(19) United States
(12) Patent Application Publication
(10) Pub. No.: US 2024/0372878 A1
(43) Pub. Date: Nov. 7, 2024

(54) NEW ENTITY DETECTION USING PROBABILISTIC DATA STRUCTURES

(71) Applicant: Microsoft Technology Licensing, LLC, Redmond, WA (US)

(72) Inventors: Andrey KARPOVSKY, Kiryat Motzkin (IL); Shay Chriba SAKAZI, Herzliya (IL); Ohad Nerya COHEN, Tirat Carmel (IL)

(21) Appl. No.: 18/310,812

(22) Filed: May 2, 2023

(51) Int. Cl. H04L 9/40; H04L 41/06

(52) U.S. Cl. CPC H04L 63/1416; H04L 41/06

(57) ABSTRACT

New entity detection using probabilistic data structures is disclosed herein. In response to detecting a network event, a lookup is performed on a probabilistic data structure to determine whether an identifier associated with the network event exists in the probabilistic data structure. An action is performed if it is determined that the first identifier does not exist in the probabilistic data structure.

### BACKGROUND

Intrusion detection systems (IDS) may detect the anomalous appearance of new entities or behaviors in traffic logs. For example, an IDS might note network access from a new user or IP address, execution of a new type of query or process, a high-level command issued from an external source, etc. If the appearance of such new entity or activity is anomalous, it could indicate a security breach—such as access using a compromised user identifier, a breach in firewall rules, or a cross site scripting (XSS) attempt. Detection of such cases commonly involves identification of new entity or behavior previously unseen in stored traffic logs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for new entity detection using probabilistic data structures. In response to detecting a network event, a lookup is performed on a probabilistic data structure to determine whether an identifier associated with the network event exists in the probabilistic data structure. An action is performed if it is determined that the first identifier does not exist in the probabilistic data structure.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system that contains a server configured for network intrusion detection using probabilistic data structures, in accordance with an example embodiment.

FIG. 2 shows a block diagram of an example system for network intrusion detection using probabilistic data structures, in accordance with an embodiment.

FIG. 3 depicts a flowchart of a process for network intrusion detection using probabilistic data structures, in accordance with an embodiment.

FIG. 4 shows a block diagram of an example system for inserting an identifier into a probabilistic data structure, in accordance with an embodiment.

FIG. 5 depicts a flowchart of a process for inserting an identifier into a probabilistic data structure, in accordance with an embodiment.

FIG. 6 shows a block diagram of an example system for network intrusion detection using probabilistic data structures, in accordance with an embodiment.

FIG. 7 depicts a flowchart of a process for performing a lookup on a probabilistic data structure, in accordance with an embodiment.

FIG. 8 depicts a flowchart of a process for network intrusion detection using probabilistic data structures, in accordance with an embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A network-based Intrusion detection system (IDS) may detect the anomalous appearance of new entities or behaviors in traffic logs by storing identifiers associated with encountered entities and behaviors, and searching the stored identifiers to determine whether an entity or behavior is new. However, when resources have very large numbers of associated existing entities (e.g., a website having many distinct users accessing from different IP (Internet protocol) addresses), this approach loses efficiency, with high storage volume utilization, computation costs, and long lookup times. Some inefficiencies may be alleviated by aggregating entities at a higher level of granularity-thus decreasing the total number of entities. For example, IP addresses can be aggregated to ranges or autonomous serial numbers (ASNs). However, quite often this is not desired (e.g. when the exact IP is needed) and sometimes not possible (e.g., when there is no generic way to aggregate usernames, process IDs (identifiers) or access keys). An additional problem is data skew, as a few resources can have abnormally large amounts of associated entities. A common solution for this is capping or sampling the lists, but this reduces accuracy due to lost information and requires additional processing.

Embodiments disclosed herein overcome these shortcomings by employing probabilistic data structures (PDS) to represent and query large lists of entities assigned to different resources or behaviors. PDSs are a class of data structures that use randomization to provide approximate answers to queries with high probability, while using much less memory than exact data structures. They are particularly useful in situations where the amount of data to be processed is large and exact answers are not required, or when the memory is limited. In an embodiment, PDSs may include, but are not limited to, Bloom filters, counting Bloom filters, Ribbon filters, XOR filters, and/or cuckoo filters.

Employing PDSs significantly improves lookup times and decreases the amount of required storage. PDSs represent lists of entities as probabilistic data structures. Adding new entities turns on (e.g., sets from “0” to “1”) different bits in the data structure, and looking for the existence of an entity is performed by checking whether relevant bits are on. Each PDS can represent either a cloud resource (such as account) or type of behavior (such as internal/external source, type of operations, etc.). In addition, data skew can be prevented by using a PDS at a generic level, not specific to individual resources. For example, a PDS can maintain a list of all users for a specific region or tenant, and can be checked to detect new users

The probabilistic nature of PDSs means that PDSs may not provide an exact answer. For example, Bloom filters have a zero probability of a false negative, but false positives are possible. In other words, a negative result means that the entity definitely does not exist in the Bloom filter, but a positive result means there is a high probability that the entity exists in the Bloom filter (e.g., indicating that the entity has previously been encountered when it may actually be a new entity). While employing PDSs may result in a loss in accuracy, this loss in accuracy can be controlled by properly sizing the PDSs. For example, for Bloom filters, the probability of a false positive can be calculated using the following formula shown as Equation 1:

$$p = {( 1 - {( 1 - \frac{1}{m} )}^{kn} )}^{k} \approx {( 1 - {e}^{- k n / m} )}^{k} \qquad Equation 1$$

where n is the number of entities (e.g., unique identifiers), m is the size (e.g., length) of the PDS in bits, and k is the number of uniform and independent hash functions. Thus, the probability of a false positive can be decreased by increasing the size (e.g., length) of the PDS and/or adding additional uniform and independent hash functions. However, increasing the size (e.g., length) of the PDS will result in additional storage costs. Furthermore, adding additional uniform and independent hash functions will result in additional computational costs associated with adding entities to the PDS and performing lookups on the PDS.

As an additional benefit, PDSs have monoid properties with a well-defined and flexible algebra of operations (such as lookup, union and intersect) that allow for the detection of a large number of network security scenarios. For example, an IDS can detect different security scenarios by combining lookup results from a plurality of PDSs that represent relevant features (e.g., source of access, type of activity, authentication type, query type or resource accessed, etc.) and/or relevant entities (e.g., usernames, access tokens, device identifiers, application identifiers, query identifier, process identifiers, etc.) By combining lookup results from a plurality of PDSs, an IDS can detect a previously encountered user (e.g., by username) accessing a resource via a new means (e.g., new device identifier or IP address).

In an embodiment, an IDS employs a PDS to determine whether an identifier associated with a network event is new. For example, the IDS may detect a network event associated with a resource. In some embodiments, this includes determining the occurrence of the network event by monitoring and/or analyzing network logs. In an embodiment, a lookup is performed on the PDS to determine whether the identifier exists in the PDS. The identifier is considered, with a high probability, to be new if it is determined that the identifier does not exist in the PDS. In response, the IDS may perform a first action, including, but not limited to, logging the network event, providing an alert or a notification to at least one of an owner or administrator of the resource, denying access to the resource, dropping traffic associated with the network event, rerouting traffic associated with the network event, isolating traffic associated with the network event, and/or terminating a connection associated with the network event.

In an embodiment, the IDS may perform one or more lookup operations on the PDS using one or more index keys generated by hashing the identifier with one or more uniform and independent hash functions. The presence of the identifier in the PDS can be determined based on the values of returned by the lookup operations. For example, when the PDS is a Bloom filter, a value of zero (“0”) returned by any of the lookup operations indicates that the identifier does not exist in the Bloom filter, while values of one (“1”) returned by all of the lookup operations indicate that there is a high probability that the identifier does exist in the Bloom filter.

In an embodiment, the IDS may perform a second action based on rules comprising a plurality of conditions associated with a plurality of PDSs. For example, the IDS may perform a second action when a first identifier does not exist in a first PDS and a second identifier exists (with a high probability) in a second PDS. In an embodiment, the first PDS may be associated with a first type of identifier (e.g., IP address) and the second PDS may be associated with a second type of identifier (e.g., username). By combining lookup results from a plurality of PDSs, various rules may be applied to detect various security scenarios (e.g., a user logging in from a new IP address). In an embodiment, rules may combine any number of identifiers from any number of PDSs to detect various security scenarios. Moreover, in an embodiment, rules may combine any number of lookup results from the same PDS.

These and further embodiments are disclosed herein that enable the functionality described above and further such functionality. Such embodiments are described in further detail as follows.

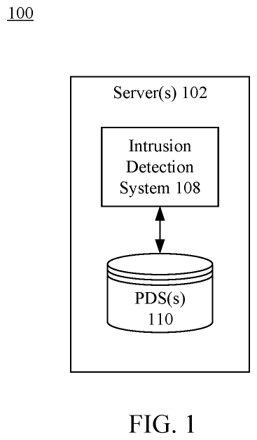

For instance, FIG. 1 shows a block diagram of an example system 100 for detecting network intrusions using probabilistic data structures, in accordance with an embodiment. As shown in FIG. 1, system 100 may include one or more servers 102 that may include an intrusion detection system (IDS) 108, and one or more PDSs 110. While not depicted in system 100, server(s) 102 may be connected to one or more networks such as local area networks (LANs), wide area networks (WANs), personal area network (PANs), enterprise networks, the Internet, etc., and may include wired and/or wireless portions. Examples of network(s) include those described below in reference to network 904 of FIG. 9.

Server(s) 102 may include any computing device suitable for performing functions that are ascribed thereto in the following description, as will be appreciated by persons skilled in the relevant art(s), including those mentioned elsewhere herein or otherwise known. Various example implementations of server(s) 102 are described below in reference to FIG. 9 (e.g., computing device 902, network-based server infrastructure 970, and/or on-premises servers 992).

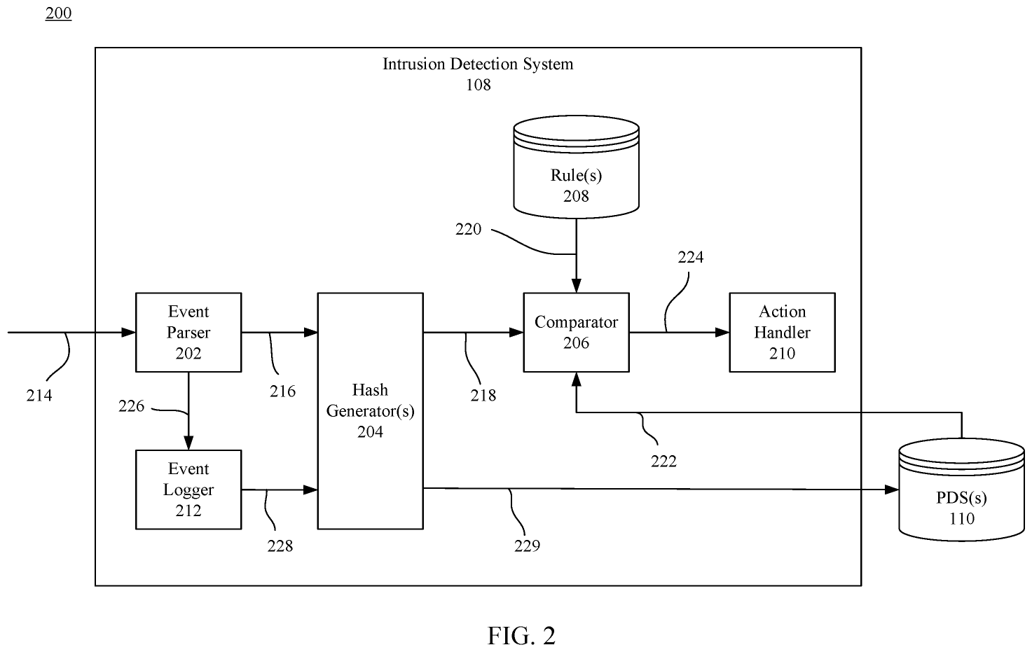

IDS 108 detects and responds to network intrusion events. In an embodiment, IDS 108 may detect network intrusion events using PDS(s) 110. In an embodiment, IDS 108 populates PDS(s) 110 with identifiers associated with entities and/or behaviors that are encountered by IDS 108 in detected network events. In an embodiment, IDS 108 may query PDS(s) 110 to determine whether an encountered identifier is new. IDS 108 will be described in greater detail below in conjunction with FIG. 2.

PDS(s) 110 comprise one or more probabilistic data structures that store representations of identifiers. In an embodiment, PDS(s) may store identifiers associated with entities, behaviors, and/or network events that are detected by IDS 108. As discussed above, PDS(s) 110 may include, but are not limited to, Bloom filters, counting Bloom filters, Ribbon filters, XOR filters, and/or cuckoo filters. Other types and/or variants of probabilistic data structures may also be used to implement the embodiments disclosed herein.

In an embodiment, PDS(s) 110 may include a separate PDS for each feature that is monitored. For instance, PDS(s) 110 may include a separate PDS for each type of identifier that is logged, including, but not limited to, IP addresses, operation identifiers, usernames, authentication methods, identifiers of resources or data accessed, access tokens, device identifiers, application identifiers, query identifiers, process identifier, and/or any other identifier detectable and/or determinable by IDS 108. In an embodiment, PDS(s) may be queried by IDS 108 to determine whether an encountered identifier exists (with a high probability) in the PDS corresponding to the identifier type.

System 100 of FIG. 1 may be configured in various ways, in embodiments. For instance, in an embodiment, IDS 108 may detect and respond to network intrusion events based on one or more rules, such as shown in FIG. 2. FIG. 2 shows a block diagram of an example system 200 for rules-based network intrusion detection using probabilistic data structures, in accordance with an embodiment. As shown in FIG. 2, system 200 includes IDS 108 and PDS(s) 110 of FIG. 1. In the embodiment of FIG. 2, IDS 108 further includes an event parser 202, one or more hash generators 204, a comparator 206, one or more rules 208, an action handler 210, and an event logger 212. These features of system 200 are described in further detail as follows.

Event parser 202 may receive and parse network event information 214 to determine one or more identifiers 216 and/or 226 associated with a network event. In an embodiment, network event information 214 may include, but are not limited to, monitored network traffic (e.g., network frames and/or packets), network traffic logs (e.g., logs generated based on monitored and/or detected network events and/or traffic), network system logs (e.g., system logs generated by one or more network nodes), and/or any other network information that may be monitored by an IDS. In an embodiment, identifier(s) 216 and/or 226 may include, but are not limited to, IP addresses, operation identifiers, usernames, authentication methods, identifiers of resources or data accessed, access tokens, device identifiers, application identifiers, query identifiers, process identifier, and/or any other identifier detectable and/or determinable by event parser 202. In an embodiment, event parser 202 may provide identifiers 216 to hash generator(s) 204 and/or identifiers 226 to event logger 212. In embodiments, identifiers 216 may include the same and/or different from identifiers 226.

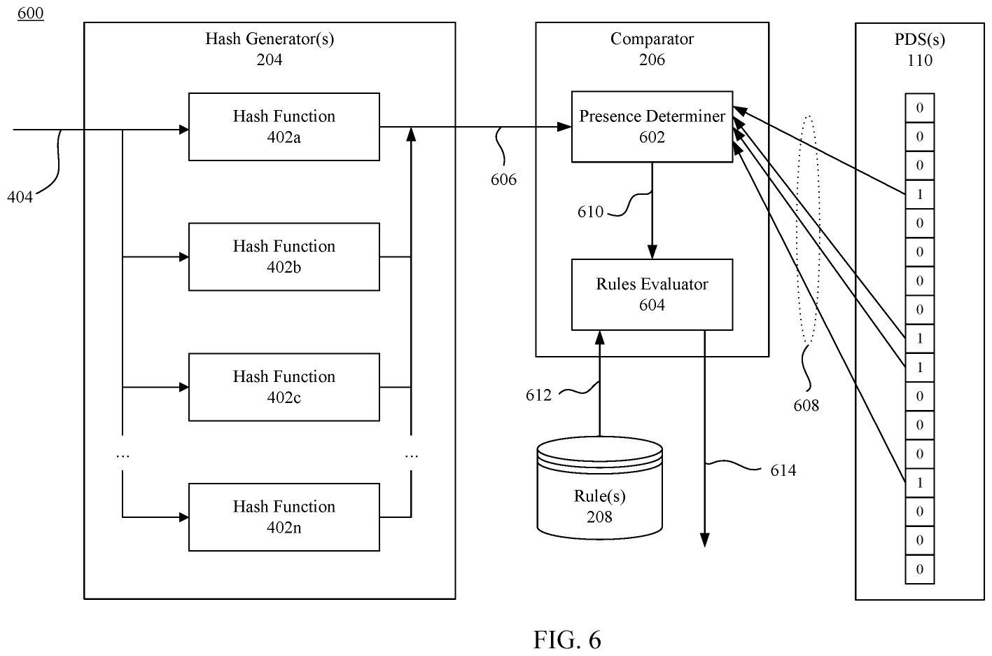

Hash generator(s) 204 may each include one or more uniform and independent hash functions that map an identifier to an element PDS(s) 110. In an embodiment, hash generator(s) 204 may receive one or more identifiers 216 from event parser 202, and/or one or more identifiers 228 from event logger 212. In an embodiment, hash generator(s) 204 process identifier(s) 216 and/or identifier(s) 228 based on the identifier type and/or based on the PDS(s) associated with the identifier type. For instance, each hash generator(s) 204 may be associated with one or more types of identifiers and/or one or more of PDS(s) 110. In an embodiment, hash generator(s) 204 is/are configured to perform a hash on identifier(s) 216 and/or identifier(s) 228 using the uniform and independent hash function(s) to map each identifier to one or more elements of PDS(s) 110. In an embodiment, one or more hash values 218 generated by hash generator(s) 204 may be provided to comparator 206. In an embodiment, the output from hash generator(s) 204 may indicate one or more elements of PDS(s) 110 that correspond to identifier(s) 228, and the element(s) identified by hash generator(s) may be updated to insert identifier(s) 228 into PDS(s) 110. Hash generator(s) 204 will be discussed in greater detail below in conjunction with FIGS. 6-8.

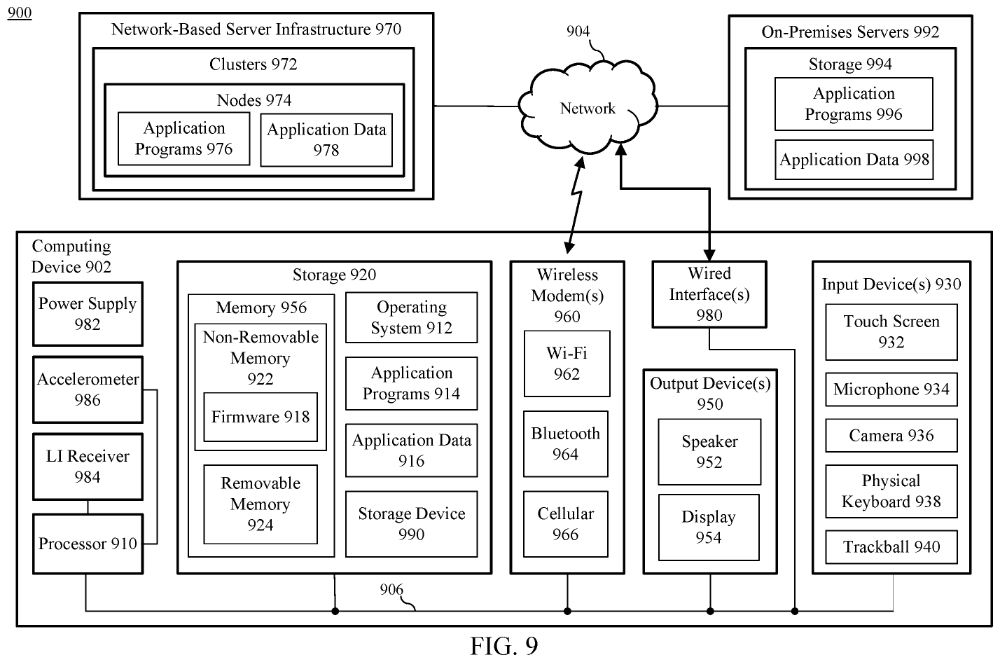

Comparator 206 may determine whether an encountered identifier associated with an entity or behavior is new by performing a lookup on the PDS(s) 110 corresponding to the identifier type of the encountered identifier. In an embodiment, comparator 206 may receive hash value(s) 218 for identifier(s) 216 from hash generator(s) 204, and perform one or more lookups on PDS(s) 110 using hash value(s) 218 as an index key. In an embodiment, comparator 206 determines whether identifier(s) 216 exists in PDS(s) 110 based on one or more elements 222 returned by the lookup(s). For instance, if PDS(s) 110 is a Bloom filter, a result of zero (“0”) from any of the lookup(s) indicates that identifier(s) 216 is not in PDS(s) 110, and results of one (“1”) from all of the lookup(s) indicates a high probability that identifier(s) 216 exist in PDS(s) 110. In an embodiment, comparator 206 may perform the lookup(s) one at a time, a plurality at a time in batches, or all at the same time in parallel. Performing the lookup(s) one at a time may result in computation cost savings because the first lookup may indicate that identifier(s) 216 is not in PDS(s) 110. However, performing lookup(s) one at a time will take longer to determine that identifier(s) 216 does exist in PDS(s) 110. Performing the lookup(s) all at the same time in parallel results in higher computational costs on average, but will take less time. In an embodiment, a balance may be achieved by performing the lookup(s) a plurality at a time in batches. Comparator 208 may also determine whether apply rule(s) 208 should be applied based on the outcome of the lookup(s). When the condition(s) of rule(s) 208 are met, comparator 206 may provide one or more indications 224 to action handler 210. In an embodiment, indication(s) 224 may identify the rule(s) 208 and/or the action(s) to be performed. Comparator 206 will be discussed in greater detail below in conjunction with FIG. 8.

Rule(s) 208 may include one or more conditions and/or one or more actions to be performed when the condition(s) are met. In an embodiment, rule(s) 208 may be defined by an administrator of the network and/or an owner or administrator (e.g., tenant) of a network resource residing on the network. Alternatively or additionally, rule(s) 208 may be automatically generated by IDS 108 in response to monitoring and/or analyzing the network. The condition(s) may include, but are not limited to, whether identifier(s) 216 are present or absent from PDS(s) 110. In an embodiment, the condition(s) may be based on the presence and/or absence of identifier(s) 216 of a single type in PDS(s) 110, or based on the presence and/or absence of identifier(s) 216 of different types in PDS(s) 110. For example, rule(s) 208 combining a plurality of conditions allows IDS 108 to detect a variety of different security scenarios. For example, IDS 108 can detect a previously encountered user (e.g., presence of username in a PDS) accessing a resource via a new means (e.g., absence of device identifier or IP address in a PDS).

Action handler 210 may receive indication(s) 224 that rule(s) 208 have been triggered when the condition(s) of rule(s) 208 have been met. In an embodiment, action handler 210 may perform one or more actions associated with rule(s) 208 in response to the received indication. In an embodiment, indication(s) 224 may identify the rule(s) 208 and/or the action(s) to be performed. In an embodiment, the action(s) may include, but are not limited to, logging the network events that triggered rule(s) 208, providing an alert or a notification to at least one of an owner or administrator of a resource being accessed by the network event, denying access to the resource, dropping traffic associated with the network event, rerouting traffic associated with the network event, isolating traffic associated with the network event, terminating a connection associated with the network event, and/or any other remedial action to prevent and/or correct any damage to the network and/or the resource.

Event logger 212 may receive from event parser 202 identifier(s) 226 associated with network events, and provide identifier(s) 226 to hash generator(s) 204 to add to PDS(s) 110. In an embodiment, event logger 212 may determine an identifier type for identifier(s) 226 and provide identifier(s) 226 to hash generator(s) 204 that corresponds to the identifier type. Event logger 212 may provide identifier(s) 226 to hash generator(s) 204 as identifier(s) 228.

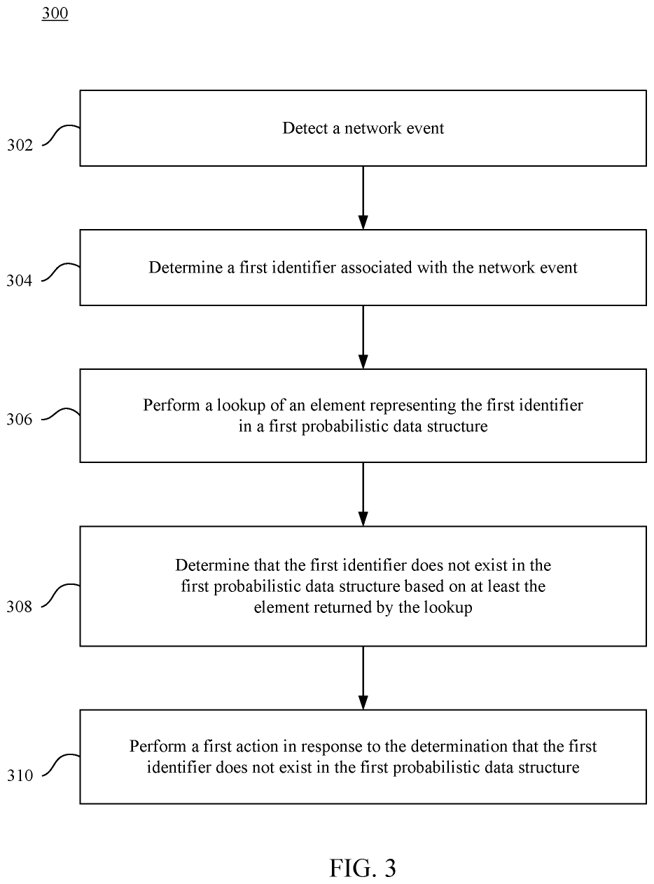

Embodiments described herein may operate in various ways to detect network intrusion events using probabilistic data structures. For instance, FIG. 3 depicts a flowchart 300 of a process for network intrusion detection using probabilistic data structures, in accordance with an embodiment. Server(s) 102 of FIG. 1 and/or IDS 108 of FIGS. 1 and 2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a network event is detected. For example, event parser 202 may receive network event information 214. As discussed above, network event information 214 may include, but are not limited to, monitored network traffic (e.g., network frames and/or packets), network traffic logs (e.g., logs generated based on monitored and/or detected network events and/or traffic), network system logs (e.g., system logs generated by one or more network nodes), and/or any other network information that may be monitored by an IDS.

In step 304, a first identifier associated with the network event is determined. For example, event parser 202 may parse and/or analyze event information 214 to determine identifier(s) 216 associated with the network event. As discussed above, identifier(s) 216 may, but are not limited to, IP addresses, operation identifiers, usernames, authentication methods, identifiers of resources or data accessed, access tokens, device identifiers, application identifiers, query identifiers, process identifier, and/or any other identifier detectable and/or determinable by event parser 202. Event parser 202 may provide identifier(s) 216 to hash generator(s) 204.

In step 306, a lookup of an element representing the first identifier in a first probabilistic data structure is performed. For example, comparator 206 may receive hash value(s) 218 from hash generator(s) 204, and perform a lookup on PDS(s) 110 using hash value(s) 218 as index keys. In an embodiment, comparator 206 receives element(s) 222 from PDS(s) 110.

In step 308, it is determined that the first identifier does not exist in the first probabilistic data structure based on at least the element returned by the lookup. For example, comparator 206 may determine whether identifier(s) 216 exists in PDS(s) 110 based on element(s) 222. For example, when PDS(s) 110 is a Bloom filter, when any of returned element(s) 222 have a value of zero (“0”), identifier(s) 216 does not exist in PDS(s) 110, and when all returned element(s) 222 have values of one (“1”), there is a high probability that identifier(s) 216 does exist in PDS(s) 110.

In step 310, a first action is performed in response to the determination that the first identifier does not exist in the first probabilistic data structure. For example, action handler 210 may perform one or more actions in response to receiving indication(s) 224 from comparator 206 that identifier(s) 216 does not exist in PDS(s) 110. As discussed above, the action(s) may include, but are not limited to, logging the network events that triggered rule(s) 208, providing an alert or a notification to at least one of an owner or administrator of a resource being accessed by the network event, denying access to the resource, dropping traffic associated with the network event, rerouting traffic associated with the network event, isolating traffic associated with the network event, terminating a connection associated with the network event, and/or any other remedial action to prevent and/or correct any damage to the network and/or the resource. The action(s) may be defined in rule(s) 208 by an administrator of the network and/or an owner or administrator (e.g., tenant) of a network resource residing on the network. Alternatively or additionally, the action(s) in rule(s) 208 may be automatically generated by IDS 108 in response to monitoring and/or analyzing the network.

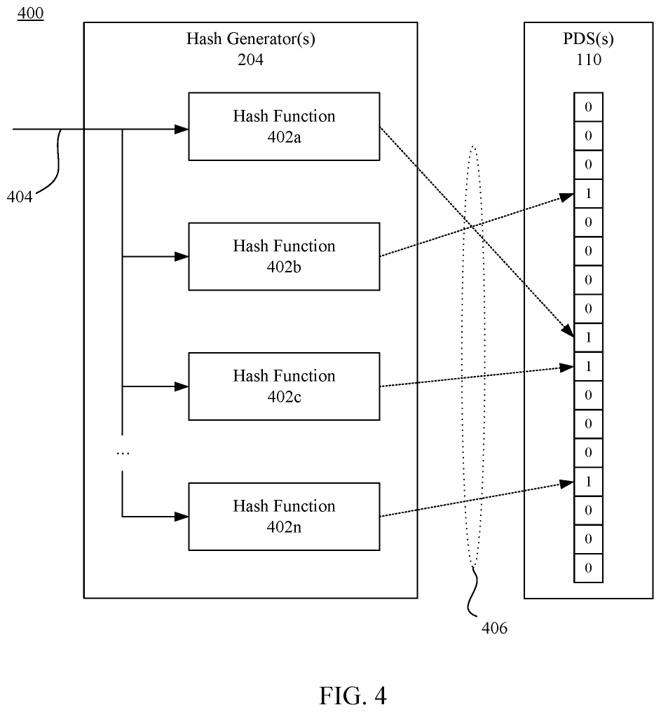

In embodiments, IDS 108 tracks identifiers associated with entities and behaviors using probabilistic data structures. For instance, FIG. 4 shows a block diagram of an example system 400 for inserting an identifier into a probabilistic data structure, in accordance with an embodiment. As shown in FIG. 4, system 400 includes PDS(s) 110 as shown and described with respect to FIGS. 1 and 2, and hash function(s) 204 as shown and described with respect to FIG. 2. Hash generator(s) 204 further includes one or more hash functions 402a-402n. These features of system 400 are described in further detail as follows.

Hash generator(s) 204 may each include a set of hash function(s) 402a-402n that are uniform and independent hash functions. While FIG. 4 depicts four hash function(s) 402a-402n, in embodiments, any number of hash functions may be included in hash generator(s) 204. In an embodiment, hash function(s) 402a-402n may each receive an identifier 404 and calculate a hash value 406 of identifier 404. In an embodiment, identifier 404 may include one or more of identifier(s) 226 as described in conjunction with FIGS. 2 and 3 above. Hash value(s) 406 generated by hash function(s) 402a-402n may act as index keys to one or more elements of PDS(s) 110, where each hash value 406 maps to an element of PDS(s) 110. In an embodiment, each different identifier 404 will map to a different combination of element(s) of PDS(s) 110. In an embodiment, when identifier 404 is encountered, hash generator(s) 204 maps identifier 404 to element(s) of PDS(s) 110, and updates the element(s) of PDS(s) 110 to reflect the encounter of identifier 404. In an embodiment where PDS(s) 110 is a Bloom filter, the element(s) of PDS(s) 110 identified by the output of hash function(s) 402a-402n are updated to a value of one (“1”). In other embodiments where PDS(s) are different probabilistic data structures, the value of the element(s) may be updated to a different value to reflect the encounter of identifier 404.

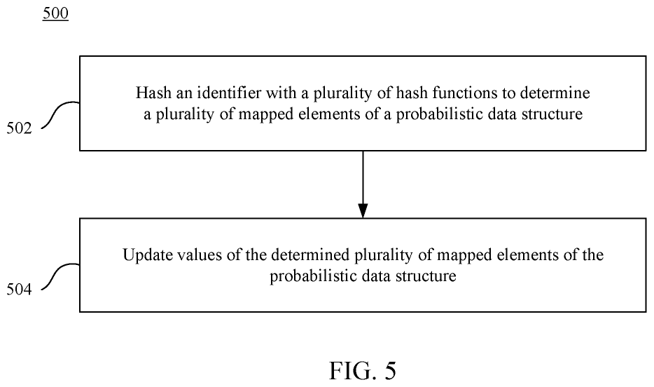

Embodiments described herein may operate in various ways to detect network intrusion events using probabilistic data structures. For instance, FIG. 5 depicts a flowchart 500 of a process for inserting an identifier into a probabilistic data structure, in accordance with an embodiment. Server(s) 102 of FIG. 1, IDS 108 of FIGS. 1 and 2, and/or hash generator(s) 204 of FIGS. 2 and 4 may operate according to flowchart 500, for example. Flowchart 500 is described as follows with respect to FIGS. 1, 2 and 4 for illustrative purposes.

Flowchart 500 starts at step 502. In step 502, an identifier is hashed with a plurality of hash functions to determine a plurality of mapped elements of a probabilistic data structure. For example, hash function(s) 402a-402n may hash identifier 404 to generate hash value(s) 406 that map to element(s) of PDS(s) 110.

In step 504, the values of the determined plurality of mapped elements of the probabilistic data structure are updated. For example, hash generator(s) 204 may update the mapped element(s) of PDS(s) 110 to reflect the encounter of identifier 404. As discussed above, when PDS(s) 110 is a Bloom filter, the element(s) of PDS(s) 110 identified by the output of hash function(s) 402a-402n are updated to a value of one (“1”). In other embodiments where PDS(s) are different probabilistic data structures, the value of the element(s) may be updated to a different value to reflect the encounter of identifier 404.

In embodiments, IDS 108 tracks identifiers associated with entities and behaviors using probabilistic data structures. For instance, FIG. 6 shows a block diagram of an example system 600 for detecting and responding to network intrusion events using probabilistic data structures, in accordance with an embodiment. As shown in FIG. 6, system 600 includes PDS(s) 110 as shown and described with respect to FIGS. 1, 2, and 4, hash generator(s) 204 as shown and described with respect to FIGS. 2 and 4, and comparator 206 and rule(s) 208 as shown and described with respect to FIG. 2. Comparator 206 further includes a presence determiner 602 and a rules evaluator 604. These features of system 600 are described in further detail as follows.

Hash generator(s) 204 may receive identifier(s) 404 and calculate hash value(s) 606 for identifier 404 using hash function(s) 402a-402n. In an embodiment, hash value(s) 606 generated by hash function(s) 402a-402n may act as index keys to one or more elements of PDS(s) 110, where each hash value 606 maps to an element of PDS(s) 110. In an embodiment, identifier(s) 404 may include one or more of identifier(s) 226 as described in conjunction with FIGS. 2 and 3 above. In an embodiment, each different identifier 404 will map to a different combination of element(s) of PDS(s) 110. Hash generator(s) 204 provides hash value(s) 606 to presence determiner 602.

Presence determiner 602 may receive hash value(s) 606 from hash generator(s) 204 and use hash value(s) 606 to perform one or more lookups on PDS(s) 110. In an embodiment, presence determiner 602 determines whether identifier(s) 404 exists in PDS(s) 110 based on one or more elements 608 returned by the lookup(s). For instance, if PDS(s) 110 is a Bloom filter, a result of zero (“0”) from any of the lookup(s) indicates that identifier(s) 404 is not in PDS(s) 110, and results of one (“1”) from all of the lookup(s) indicates a high probability that identifier(s) 404 exist in PDS(s) 110. In embodiments, presence determiner 602 may perform the lookup(s) one at a time, a plurality at a time in batches, or all at the same time in parallel. As discussed above, performing the lookup(s) one at a time may result in computation cost savings because the first lookup may indicate that identifier(s) 404 is not in PDS(s) 110. However, performing lookup(s) one at a time will take longer to determine that identifier(s) 404 does exist in PDS(s) 110. Performing the lookup(s) all at the same time in parallel results in higher computational costs on average, but will take less time. In an embodiment, a balance may be achieved by performing the lookup(s) a plurality at a time in batches. Presence determiner 602 may provide one or more presence determinations 610 to rules evaluator 604. In an embodiment, presence determination(s) 610 may indicate the presence or absence of identifier(s) 404 in PDS(s) 110.

Rules evaluator 604 may obtain one or more rules 612 from rule(s) 208 and determine whether one or more conditions of rule(s) 612 are met based on presence determination(s) 610 provided by presence determiner 602. Rule(s) 612 may include one or more conditions and/or one or more actions to be performed when the condition(s) are met. In an embodiment, rule(s) 612 may be defined by an administrator of the network and/or an owner or administrator (e.g., tenant) of a network resource residing on the network. Alternatively or additionally, rule(s) 612 may be automatically generated by IDS 108 in response to monitoring and/or analyzing the network. The condition(s) may include, but are not limited to, whether identifier(s) 404 are present or absent from PDS(s) 110. In an embodiment, the condition(s) may be based on the presence and/or absence of identifier(s) 404 of a single type in PDS(s) 110, or based on the presence and/or absence of identifier(s) 404 of different types in PDS(s) 110. For example, rule(s) 612 combining a plurality of conditions allows IDS 108 to detect a variety of different security scenarios. For example, IDS 108 can detect a previously encountered user (e.g., presence of username in a PDS) accessing a resource via a new means (e.g., absence of device identifier or IP address in a PDS). In an embodiment, rules evaluator 604 may provide, to action handler 210, one or more indications 614 in response to determining that the condition(s) of rule(s) 612 have been satisfied. In an embodiment, indication(s) 614 may identify the rule(s) 612 and/or the action(s) to be performed.

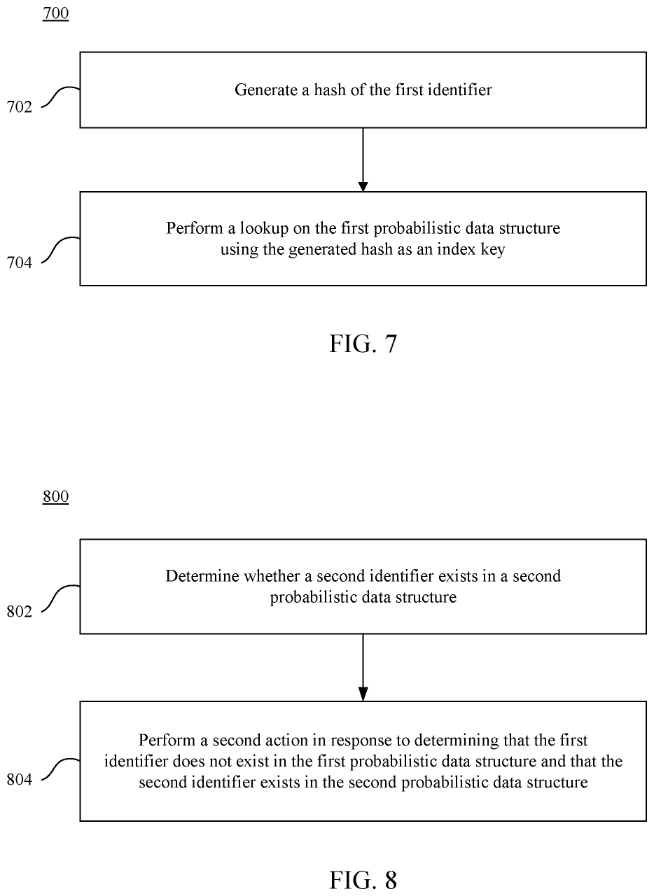

Embodiments described herein may operate in various ways to perform a lookup on probabilistic data structures. For instance, FIG. 7 depicts a flowchart 700 of a process for performing a lookup on a probabilistic data structure, in accordance with an embodiment. Server(s) 102 of FIG. 1, IDS 108 of FIGS. 1 and 2, hash generator(s) 204 of FIGS. 1, 2 and 6, and/or comparator 206 of FIGS. 1, 2 and 6 may operate according to flowchart 700. Flowchart 700 is described as follows with respect to FIGS. 1, 2 and 6 for illustrative purposes.

Flowchart 700 starts at step 702. In step 702, a hash of the first identifier is generated. For example, hash function(s) 402a-402n may generate hash value(s) 606 for identifier(s) 404. In an embodiment, hash value(s) 606 are provided to presence determiner 602.

In step 704, a lookup is performed on the first probabilistic data structure using the generated hash as an index key. For example, presence determiner may perform one or more lookups on PDS(s) 110 using hash value(s) 606 as index keys. In an embodiment, element(s) 608 corresponding to hash value(s) 606 are returned to presence determiner 602.

Embodiments described herein may operate in various ways to detect network intrusion events using probabilistic data structures. For instance, FIG. 8 depicts a flowchart 800 of a process for network intrusion detection using probabilistic data structures, in accordance with an embodiment. Server(s) 102 of FIG. 1, IDS 108 of FIGS. 1 and 2, and/or comparator 206 of FIGS. 1, 2 and 6 may operate according to flowchart 800. Flowchart 800 is described as follows with respect to FIGS. 1, 2 and 6 for illustrative purposes.

Flowchart 800 starts at step 802. In step 802, it is determined whether a second identifier exists in a second probabilistic data structure. For example, presence determiner 602 may receive hash value(s) 606 corresponding to identifier(s) 404 from hash function(s) 402a-402n, and perform a lookup on PDS(s) 110 using hash value(s) 606 as index keys. In an embodiment, presence determiner 602 may evaluate the returned element(s) 608 to determine whether identifier(s) 404 are present or absent from PDS(s) 110. In an embodiment, presence determiner 602 may perform such a determination for a plurality of or all identifier(s) 404.

In step 804, a second action is performed in response to determining that the first identifier does not exist in the first probabilistic data structure and that the second identifier exists in the second probabilistic data structure. For example, action handler 210 may perform a second action responsive to receiving indication(s) 614 from rules evaluator 604. In an embodiment, indication(s) 614 may identify the rule(s) 612 and/or the action(s) to be performed. As discussed above, rule(s) 612 may include one or more conditions and/or one or more actions to be performed when the condition(s) are met. The condition(s) may include, but are not limited to, whether identifier(s) 404 are present or absent from PDS(s) 110. In an embodiment, the condition(s) may be based on the presence and/or absence of identifier(s) 404 of a single type in PDS(s) 110, or based on the presence and/or absence of identifier(s) 404 of different types in PDS(s) 110. For example, rule(s) 612 combining a plurality of conditions allows IDS 108 to detect a variety of different security scenarios. For example, IDS 108 can detect a previously encountered user (e.g., presence of username in a PDS) accessing a resource via a new means (e.g., absence of device identifier or IP address in a PDS). In an embodiment, rules evaluator 604 may provide, to action handler 210, one or more indications 614 in response to determining that the condition(s) of rule(s) 612 have been satisfied.

### III. Example Mobile Device and Computer System Implementation

The systems and methods described above in reference to FIGS. 1-8, server(s) 102, IDS 108, PDS(s) 110, event parser 202, hash generator(s) 204, comparator 206, rule(s) 208, action handler 210, event logger 212, hash function(s) 602a-602n, presence determiner 802, rules evaluator 804, and/or each of the components described therein, and/or the steps of flowcharts 300, 400, 500, and/or 700 may be each implemented as computer program code/instructions configured to be executed in one or more processors and stored in a computer readable storage medium, and structured to performed the respective flowchart functions/operations. Alternatively, server(s) 102, IDS 108, PDS(s) 110, event parser 202, hash generator(s) 204, comparator 206, rule(s) 208, action handler 210, event logger 212, hash function(s) 602a-602n, presence determiner 802, rules evaluator 804, and/or each of the components described therein, and/or the steps of flowcharts 300, 400, 500, and/or 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 9. FIG. 9 shows a block diagram of an exemplary computing environment 900 that includes a computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc., and may include one or more wired and/or wireless portions. Network 904 may additionally or alternatively include a cellular network for cellular communications. Computing device 902 is described in detail as follows

Computing device 902 can be any of a variety of types of computing devices. For example, computing device 902 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 902 may alternatively be a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, one or more input devices 930, one or more output devices 950, one or more wireless modems 960, one or more wired interfaces 980, a power supply 982, a location information (LI) receiver 984, and an accelerometer 986. Storage 920 includes memory 956, which includes non-removable memory 922 and removable memory 924, and a storage device 990. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 930 includes a touch screen 932, a microphone 934, a camera 936, a physical keyboard 938, and a trackball 940. Not all components of computing device 902 shown in FIG. 9 are present in all embodiments, additional components not shown may be present, and any combination of the components may be present in a particular embodiment. These components of computing device 902 are described as follows.

A single processor 910 (e.g., central processing unit (CPU), microcontroller, a microprocessor, signal processor, ASIC (application specific integrated circuit), and/or other physical hardware processor circuit) or multiple processors 910 may be present in computing device 902 for performing such tasks as program execution, signal coding, data processing, input/output processing, power control, and/or other functions. Processor 910 may be a single-core or multi-core processor, and each processor core may be single-threaded or multithreaded (to provide multiple threads of execution concurrently). Processor 910 is configured to execute program code stored in a computer readable medium, such as program code of operating system 912 and application programs 914 stored in storage 920. Operating system 912 controls the allocation and usage of the components of computing device 902 and provides support for one or more application programs 914 (also referred to as “applications” or “apps”). Application programs 914 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 902 can communicate with any other component according to function, although not all connections are shown for case of illustration. For instance, as shown in FIG. 9, bus 906 is a multiple signal line communication medium (e.g., conductive traces in silicon, metal traces along a motherboard, wires, etc.) that may be present to communicatively couple processor 910 to various other components of computing device 902, although in other embodiments, an alternative bus, further buses, and/or one or more individual signal lines may be present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 990, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 922 may include main memory and may be separate from or fabricated in a same integrated circuit as processor 910. As shown in FIG. 9, non-removable memory 922 stores firmware 918, which may be present to provide low-level control of hardware. Examples of firmware 918 include BIOS (Basic Input/Output System, such as on personal computers) and boot firmware (e.g., on smart phones). Removable memory 924 may be inserted into a receptacle of or otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 990 may be present that are internal and/or external to a housing of computing device 902 and may or may not be removable. Examples of storage device 990 include a hard disk drive, a SSD, a thumb drive (e.g., a USB (Universal Serial Bus) flash drive), or other physical storage device.

One or more programs may be stored in storage 920. Such programs include operating system 912, one or more application programs 914, and other program modules and program data. Examples of such application programs may include, for example, computer program logic (e.g., computer program code/instructions) for implementing one or more of server(s) 102, IDS 108, PDS(s) 110, event parser 202, hash generator(s) 204, comparator 206, rule(s) 208, action handler 210, event logger 212, hash function(s) 602a-602n, presence determiner 802, rules evaluator 804, and/or each of the components described therein, along with any components and/or subcomponents thereof, as well as the flowcharts/flow diagrams (e.g., flowcharts 300, 400, 500, and/or 700) described herein, including portions thereof, and/or further examples described herein.

Storage 920 also stores data used and/or generated by operating system 912 and application programs 914 as application data 916. Examples of application data 916 include web pages, text, images, tables, sound files, video data, and other data, which may also be sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 902 through one or more input devices 930 and may receive information from computing device 902 through one or more output devices 950. Input device(s) 930 may include one or more of touch screen 932, microphone 934, camera 936, physical keyboard 938 and/or trackball 940 and output device(s) 950 may include one or more of speaker 952 and display 954. Each of input device(s) 930 and output device(s) 950 may be integral to computing device 902 (e.g., built into a housing of computing device 902) or external to computing device 902 (e.g., communicatively coupled wired or wirelessly to computing device 902 via wired interface(s) 980 and/or wireless modem(s) 960). Further input devices 930 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 may display information, as well as operating as touch screen 932 by receiving user commands and/or other information (e.g., by touch, finger gestures, virtual keyboard, etc.) as a user interface. Any number of each type of input device(s) 930 and output device(s) 950 may be present, including multiple microphones 934, multiple cameras 936, multiple speakers 952, and/or multiple displays 954.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). Wireless modem 960 may also or alternatively include other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 982, LI receiver 984, accelerometer 986, and/or one or more wired interfaces 980. Example wired interfaces 980 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 980 of computing device 902 provide for wired connections between computing device 902 and network 904, or between computing device 902 and one or more devices/peripherals when such devices/peripherals are external to computing device 902 (e.g., a pointing device, display 954, speaker 952, camera 936, physical keyboard 938, etc.). Power supply 982 is configured to supply power to each of the components of computing device 902 and may receive power from a battery internal to computing device 902, and/or from a power cord plugged into a power port of computing device 902 (e.g., a USB port, an A/C power port). LI receiver 984 may be used for location determination of computing device 902 and may include a satellite navigation receiver such as a Global Positioning System (GPS) receiver or may include other type of location determiner configured to determine location of computing device 902 based on received information (e.g., using cell tower triangulation, etc.). Accelerometer 986 may be present to determine an orientation of computing device 902.

Note that the illustrated components of computing device 902 are not required or all-inclusive, and fewer or greater numbers of components may be present as would be recognized by one skilled in the art. For example, computing device 902 may also include one or more of a gyroscope, barometer, proximity sensor, ambient light sensor, digital compass, etc. Processor 910 and memory 956 may be co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein may be stored in storage 920 and executed by processor 910.

In some embodiments, server infrastructure 970 may be present in computing environment 900 and may be communicatively coupled with computing device 902 via network 904. Server infrastructure 970, when present, may be a network-accessible server set (e.g., a cloud-based environment or platform). As shown in FIG. 9, server infrastructure 970 includes clusters 972. Each of clusters 972 may comprise a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. Any of nodes 974 may be a storage node that comprises a plurality of physical storage disks, SSDs, and/or other physical storage devices that are accessible via network 904 and are configured to store data associated with the applications and services managed by nodes 974. For example, as shown in FIG. 9, nodes 974 may store application data 978.

Each of nodes 974 may, as a compute node, comprise one or more server computers, server systems, and/or computing devices. For instance, a node 974 may include one or more of the components of computing device 902 disclosed herein. Each of nodes 974 may be configured to execute one or more software applications (or “applications”) and/or services and/or manage hardware resources (e.g., processors, memory, etc.), which may be utilized by users (e.g., customers) of the network-accessible server set. For example, as shown in FIG. 9, nodes 974 may operate application programs 976. In an implementation, a node of nodes 974 may operate or comprise one or more virtual machines, with each virtual machine emulating a system architecture (e.g., an operating system), in an isolated manner, upon which applications such as application programs 976 may be executed.

In an embodiment, one or more of clusters 972 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 972 may be a datacenter in a distributed collection of datacenters. In embodiments, exemplary computing environment 900 comprises part of a cloud-based platform such as Amazon Web Services® of Amazon Web Services, Inc. or Google Cloud Platform™ of Google LLC, although these are only examples and are not intended to be limiting.

In an embodiment, computing device 902 may access application programs 976 for execution in any manner, such as by a client application and/or a browser at computing device 902. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 902 may additionally and/or alternatively synchronize copies of application programs 914 and/or application data 916 to be stored at network-based server infrastructure 970 as application programs 976 and/or application data 978. For instance, operating system 912 and/or application programs 914 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 920 at network-based server infrastructure 970.

In some embodiments, on-premises servers 992 may be present in computing environment 900 and may be communicatively coupled with computing device 902 via network 904. On-premises servers 992, when present, are hosted within an organization's infrastructure and, in many cases, physically onsite of a facility of that organization. On-premises servers 992 are controlled, administered, and maintained by IT (Information Technology) personnel of the organization or an IT partner to the organization. Application data 998 may be shared by on-premises servers 992 between computing devices of the organization, including computing device 902 (when part of an organization) through a local network of the organization, and/or through further networks accessible to the organization (including the Internet). Furthermore, on-premises servers 992 may serve applications such as application programs 996 to the computing devices of the organization, including computing device 902. Accordingly, on-premises servers 992 may include storage 994 (which includes one or more physical storage devices such as storage disks and/or SSDs) for storage of application programs 996 and application data 998 and may include one or more processors for execution of application programs 996. Still further, computing device 902 may be configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 may be used to implement systems, clients, or devices, or components/subcomponents thereof, disclosed elsewhere herein. In other embodiments, a combination of computing device 902, network-based server infrastructure 970, and/or on-premises servers 992 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk. SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 914) may be stored in storage 920. Such computer programs may also be received via wired interface(s) 980 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Additional Example Embodiments

In an embodiment, a method of intrusion detection includes: detecting a network event associated with a resource; determining a first identifier associated with the detected network event; performing a lookup of an element representing the first identifier in a first probabilistic data structure; determining the first identifier does not exist in the first probabilistic data structure based on at least the element returned by the lookup; and performing a first action in response to the determination that the first identifier does not exist in the first probabilistic data structure.

In an embodiment, performing the lookup comprises: generating a hash of the first identifier; and performing the lookup on the first probabilistic data structure using the generated hash as an index key.

In an embodiment, the method further includes: determining whether a second identifier exists in a second probabilistic data structure; and performing a second action in response to determining that the first identifier does not exist in the first probabilistic data structure and that the second identifier exists in the second probabilistic data structure.

In an embodiment, the first probabilistic data structure is associated with a first identifier type and the second probabilistic data structure is associated with a second identifier type, and the first identifier type or the second identifier type comprise: a username; an access token; a device identifier; an application identifier; a query identifier; or a process identifier.

In an embodiment, the method further includes: inserting the first identifier into the first probabilistic data structure by: hashing the first identifier with a plurality of hash functions to determine a plurality of mapped elements of the first probabilistic data structure, wherein the plurality of hash functions comprise uniform and independent hash functions that map to different elements of the first probabilistic data structure; and updating values of the determined plurality of mapped elements of the first probabilistic data structure based on said hashing the first identifier with the plurality of hash functions.

In an embodiment, the first action comprises at least one of: logging the network event; providing an alert or a notification to at least one of an owner or administrator of the resource; denying access to the resource; dropping traffic associated with the network event; rerouting traffic associated with the network event; isolating traffic associated with the network event; or terminating a connection associated with the network event.

In an embodiment, the probabilistic data structure comprises at least one of: a Bloom filter; a counting Bloom filter; a Ribbon filter; an XOR filter; or a cuckoo filter.

In an embodiment, a system for intrusion detection includes: a processor; and a memory device that stores program code structured to cause the processor to: detect a network event associated with a resource; determine a first identifier associated with the detected network event; perform a lookup of an element representing the first identifier in a first probabilistic data structure; determine the first identifier does not exist in the first probabilistic data structure based on at least the element returned by the lookup; and perform a first action in response to the determination that the first identifier does not exist in the first probabilistic data structure.

In an embodiment, to perform the lookup the program code is further structured to cause the processor to: generate a hash of the first identifier; and perform the lookup on the first probabilistic data structure using the generated hash as an index key.

In an embodiment, the program code is further structured to cause the processor to: determine whether a second identifier exists in a second probabilistic data structure; and perform a second action in response to determining that the first identifier does not exist in the first probabilistic data structure and that the second identifier exists in the second probabilistic data structure.

In an embodiment, the first probabilistic data structure is associated with a first identifier type and the second probabilistic data structure is associated with a second identifier type, and the first identifier type or the second identifier type comprise: a username; an access token; a device identifier; an application identifier; a query identifier; or a process identifier.

In an embodiment, the program code is further structured to cause the processor to: insert the first identifier into the first probabilistic data structure by: hashing the first identifier with a plurality of hash functions to determine a plurality of mapped elements of the first probabilistic data structure, wherein the plurality of hash functions comprise uniform and independent hash functions that map to different elements of the first probabilistic data structure; and updating values of the determined plurality of mapped elements of the first probabilistic data structure.

In an embodiment, the first action comprises at least one of: logging the network event; providing an alert or a notification to at least one of an owner or administrator of the resource; denying access to the resource; dropping traffic associated with the network event; rerouting traffic associated with the network event; isolating traffic associated with the network event; or terminating a connection associated with the network event.

In an embodiment, the probabilistic data structure comprises at least one of: a Bloom filter; a counting Bloom filter; a Ribbon filter; an XOR filter; or a cuckoo filter.

In an embodiment, a computer-readable storage medium comprising computer-executable instructions, that when executed by a processor, cause the processor to: detect a network event associated with a resource; determine a first identifier associated with the detected network event; perform a lookup of an element representing the first identifier in a first probabilistic data structure; determine the first identifier does not exist in the first probabilistic data structure based on at least the element returned by the lookup; and perform a first action in response to the determination that the first identifier does not exist in the first probabilistic data structure.

In an embodiment, to perform the lookup, the instructions further cause the processor to: generate a hash of the first identifier; and perform the lookup on the first probabilistic data structure using the generated hash as an index key.

In an embodiment, the instructions further cause the processor to: determine whether a second identifier exists in a second probabilistic data structure; and perform a second action when it is determined that the first identifier exists in the first probabilistic data structure and that the second identifier does not exist in the second probabilistic data structure.

In an embodiment, the first probabilistic data structure is associated with a first identifier type and the second probabilistic data structure is associated with a second identifier type, and the first identifier type or the second identifier type comprise: a username; an access token; a device identifier; an application identifier; a query identifier; or a process identifier.

In an embodiment, the instructions further cause the processor to: insert the first identifier into the first probabilistic data structure by: hashing the first identifier with a plurality of hash functions to determine a plurality of mapped elements of the first probabilistic data structure, wherein the plurality of hash functions comprise uniform and independent hash functions that map to different elements of the first probabilistic data structure; and updating values of the determined plurality of mapped elements of the first probabilistic data structure.

In an embodiment, the first action comprises at least one of: logging the network event; providing an alert or a notification to at least one of an owner or administrator of the resource; denying access to the resource; dropping traffic associated with the network event; rerouting traffic associated with the network event; isolating traffic associated with the network event; or terminating a connection associated with the network event.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed:

1. A method of intrusion detection comprising:
detecting a network event associated with a resource;
determining a first identifier associated with the detected network event;
performing a lookup of an element representing the first identifier in a first probabilistic data structure;
determining the first identifier does not exist in the first probabilistic data structure based on at least the element returned by the lookup; and
performing a first action in response to the determination that the first identifier does not exist in the first probabilistic data structure.

2. The method of claim 1, wherein said performing a lookup comprises:
generating a hash of the first identifier; and
performing the lookup on the first probabilistic data structure using the generated hash as an index key.

3. The method of claim 1, further comprising:
determining whether a second identifier exists in a second probabilistic data structure; and
performing a second action in response to determining that the first identifier does not exist in the first probabilistic data structure and that the second identifier exists in the second probabilistic data structure.

4. The method of claim 2, wherein the first probabilistic data structure is associated with a first identifier type and the second probabilistic data structure is associated with a second identifier type, and
wherein the first identifier type or the second identifier type comprise:
a username;
an access token;
a device identifier;
an application identifier;
a query identifier; or
a process identifier.

5. The method of claim 1, further comprising:
inserting the first identifier into the first probabilistic data structure by:
hashing the first identifier with a plurality of hash functions to determine a plurality of mapped elements of the first probabilistic data structure, wherein the plurality of hash functions comprise uniform and independent hash functions that map to different elements of the first probabilistic data structure; and
updating values of the determined plurality of mapped elements of the first probabilistic data structure based on said hashing the first identifier with the plurality of hash functions.

6. The method of claim 1, wherein the first action comprises at least one of:
logging the network event;
providing an alert or a notification to at least one of an owner or administrator of the resource;
denying access to the resource;
dropping traffic associated with the network event;
rerouting traffic associated with the network event;
isolating traffic associated with the network event; or
terminating a connection associated with the network event.

7. The method of claim 1, wherein the probabilistic data structure comprises at least one of:
a Bloom filter;
a counting Bloom filter;
a Ribbon filter;
an XOR filter; or
a cuckoo filter.

8. A system for intrusion detection comprising:
a processor; and
a memory device that stores program code structured to cause the processor to:
detect a network event associated with a resource;
determine a first identifier associated with the detected network event;
perform a lookup of an element representing the first identifier in a first probabilistic data structure;
determine the first identifier does not exist in the first probabilistic data structure based on at least the element returned by the lookup; and
perform a first action in response to the determination that the first identifier does not exist in the first probabilistic data structure.

9. The system of claim 8, wherein to perform the lookup the program code is further structured to cause the processor to:
generate a hash of the first identifier; and
perform the lookup on the first probabilistic data structure using the generated hash as an index key.

10. The system of claim 8, wherein the program code is further structured to cause the processor to:
determine whether a second identifier exists in a second probabilistic data structure; and
perform a second action in response to determining that the first identifier does not exist in the first probabilistic data structure and that the second identifier exists in the second probabilistic data structure.

11. The system of claim 10, wherein the first probabilistic data structure is associated with a first identifier type and the second probabilistic data structure is associated with a second identifier type, and
wherein the first identifier type or the second identifier type comprise:
a username;
an access token;
a device identifier;
an application identifier;
a query identifier; or
a process identifier.

12. The system of claim 8, wherein the program code is further structured to cause the processor to:
insert the first identifier into the first probabilistic data structure by:
hashing the first identifier with a plurality of hash functions to determine a plurality of mapped elements of the first probabilistic data structure, wherein the plurality of hash functions comprise uniform and independent hash functions that map to different elements of the first probabilistic data structure; and
updating values of the determined plurality of mapped elements of the first probabilistic data structure.

13. The system of claim 8, wherein the first action comprises at least one of:
logging the network event;
providing an alert or a notification to at least one of an owner or administrator of the resource;
denying access to the resource;
dropping traffic associated with the network event;
rerouting traffic associated with the network event;
isolating traffic associated with the network event; or
terminating a connection associated with the network event.

14. The system of claim 8, wherein the probabilistic data structure comprises at least one of:
a Bloom filter;
a counting Bloom filter;
a Ribbon filter;
an XOR filter; or
a cuckoo filter.

15. A computer-readable storage medium comprising computer-executable instructions, that when executed by a processor, cause the processor to:
detect a network event associated with a resource;
determine a first identifier associated with the detected network event;
perform a lookup of an element representing the first identifier in a first probabilistic data structure;
determine the first identifier does not exist in the first probabilistic data structure based on at least the element returned by the lookup; and
perform a first action in response to the determination that the first identifier does not exist in the first probabilistic data structure.

16. The computer-readable storage medium of claim 15, wherein to perform the lookup, the instructions further cause the processor to:
generate a hash of the first identifier; and
perform the lookup on the first probabilistic data structure using the generated hash as an index key.

17. The computer-readable storage medium of claim 15, wherein the instructions further cause the processor to:
determine whether a second identifier exists in a second probabilistic data structure; and
perform a second action when it is determined that the first identifier exists in the first probabilistic data structure and that the second identifier does not exist in the second probabilistic data structure.

18. The computer-readable storage medium of claim 17, wherein the first probabilistic data structure is associated with a first identifier type and the second probabilistic data structure is associated with a second identifier type, and
wherein the first identifier type or the second identifier type comprise:
a username;
an access token;
a device identifier;
an application identifier;
a query identifier; or
a process identifier.

19. The computer-readable storage medium of claim 15, wherein the instructions further cause the processor to:
insert the first identifier into the first probabilistic data structure by:
hashing the first identifier with a plurality of hash functions to determine a plurality of mapped elements of the first probabilistic data structure, wherein the plurality of hash functions comprise uniform and independent hash functions that map to different elements of the first probabilistic data structure; and
updating values of the determined plurality of mapped elements of the first probabilistic data structure.

20. The computer-readable storage medium of claim 15, wherein the first action comprises at least one of:
logging the network event;
providing an alert or a notification to at least one of an owner or administrator of the resource;
denying access to the resource;
dropping traffic associated with the network event;
rerouting traffic associated with the network event;
isolating traffic associated with the network event; or
terminating a connection associated with the network event.
